(19) United States
(12) Patent Application Publication
(10) Pub. No.: US 2018/0041623 A1
(43) Pub. Date: Feb. 8, 2018

(54) METHOD AND DEVICE FOR DISPLAYING APPLICATION INFORMATION

(71) Applicant: Alibaba Group Holding Limited, George Town (KY)

(72) Inventors: Yuting Song, Hangzhou (CN); Liang Li, Hangzhou (CN)

(21) Appl. No.: 15/666,435

(22) Filed: Aug. 1, 2017

(30) Foreign Application Priority Data
Aug. 5, 2016 (CN) 201610639712.7

(51) Int. Cl. H04M 1/725; H04W 88/02; G06F 3/0481; H04L 29/08; G06F 3/0484; G06F 3/0482

(52) U.S. Cl. CPC H04M 1/72522; G06F 3/04842; G06F 3/0482; G06F 3/04817; H04L 67/26; H04W 88/02

(57) ABSTRACT

Displaying notification information includes: displaying a notification box associated with a designated application on a display interface of a terminal, receiving an input associated with the notification box, and in response to receiving the input, displaying dynamic information associated with the designated application.

### CROSS REFERENCE TO OTHER APPLICATIONS

This application claims priority to People's Republic of China Patent Application No. 201610639712.7 entitled A TERMINAL, A METHOD AND MEANS FOR DISPLAYING APPLICATION INFORMATION, filed Aug. 5, 2016 which is incorporated herein by reference for all purposes.

### FIELD OF THE INVENTION

The present application relates to a field of information display. In particular, the present application relates to a terminal, a method, and means for displaying application information.

### BACKGROUND OF THE INVENTION

Currently, terminals typically only display notification information in the notification boxes. For example, in the case of chat software, in the event that new information to be displayed is obtained, the typical display interface (i.e., notification box) will only display notification information such as “XYZ has sent a new message.” If a user wishes to view other dynamic information of the application, the user is required to open the application. The steps involved are relatively burdensome and detract from the user's experience. Furthermore, users of mobile devices can be driving or doing other activities that require concentration, thus opening applications to get further information can be distracting or even dangerous.

Therefore, a method, a device, and a smart terminal for processing data on a terminal are needed in order to address the problems with displaying application information.

### BRIEF DESCRIPTION OF THE DRAWINGS

Various embodiments of the invention are disclosed in the following detailed description and the accompanying drawings.

The drawings described here are intended to further the understanding of the present application and form a part of this application. The illustrative embodiments of the present application and the descriptions thereof are intended to explain this application and do not constitute inappropriate limitation of the present application. Among the drawings:

FIG. 1 is a structural diagram of a terminal according to various embodiments of the present application.

FIG. 2 is a diagram of a screen including a notification box of an optional taxi booking application according to various embodiments of the present application.

FIG. 3 is a diagram of a screen including a notification box of an optional restaurant and banking application according to various embodiments of the present application.

FIG. 4 is a diagram of a screen including a notification box of an express delivery application according to various embodiments of the present application.

FIG. 5 is a time sequence diagram of a process for displaying application information according to various embodiments of the present application.

FIG. 6 is a structural diagram of a computer terminal according to various embodiments of the present application.

FIG. 7 is a diagram of a process for displaying application information according to various embodiments of the present application.

FIG. 8 is a diagram of a process for displaying application information according to various embodiments of the present application.

FIG. 9 is a flowchart of a process for displaying application information according to various embodiments of the present application.

FIG. 10 is a structural block diagram of a computer terminal according to various embodiments of the present application.

FIG. 11 is a flowchart of a process for displaying application information according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

Please note that the terms “first,” “second,” and so on in the description and claims of the present application and in the drawings described above are for differentiating between similar objects and do not have to be for describing specific sequences or chronological orders. It should be understood that data used in this way is interchangeable under appropriate circumstances so that present application embodiments described here may be implemented according to sequences other than those in the drawings or descriptions here. In addition, the terms “comprising” or “having” and any variations thereof are intended to be non-exclusive. For example, processes, methods, systems, products or equipment containing a series of steps or units need not be limited to those steps or units that are clearly listed, but may also include other steps or units that were not clearly listed or that are intrinsic to these processes, methods, products, or equipment.

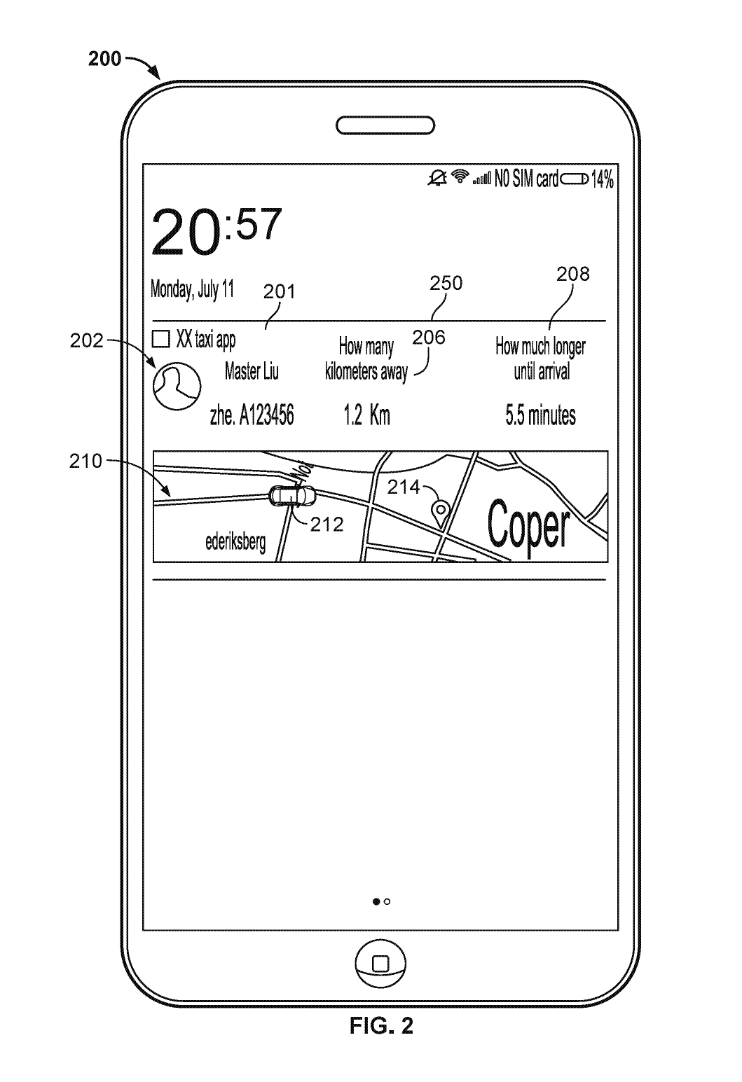

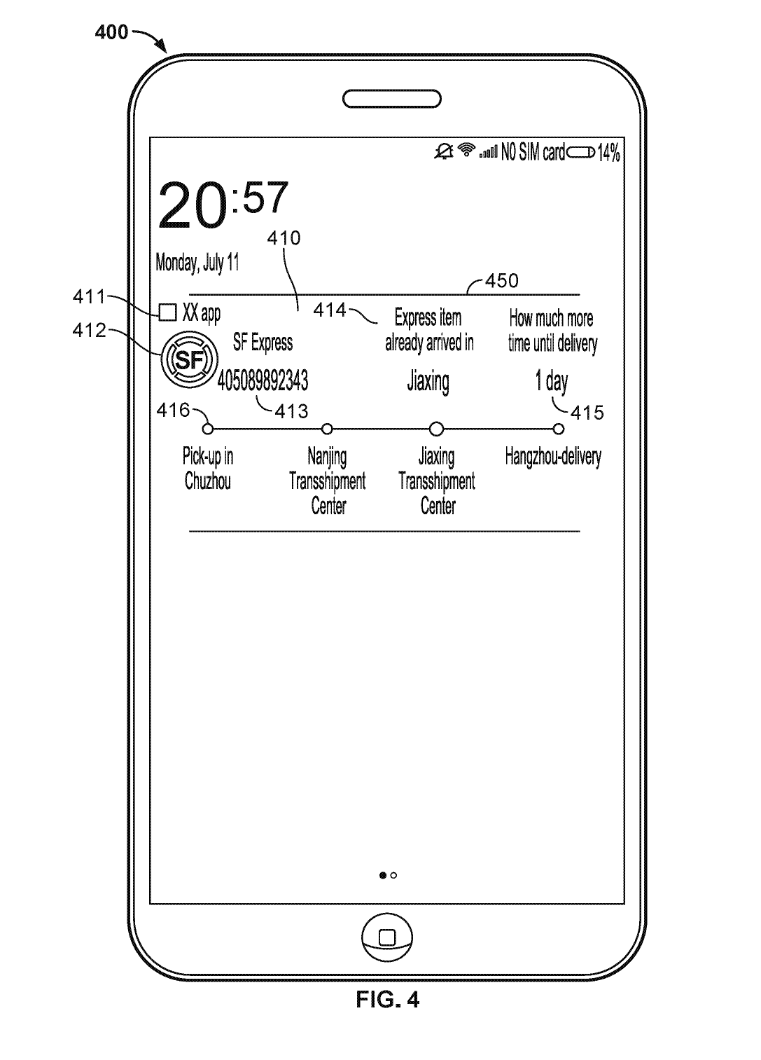

As used herein, a notification box (also referred to as a popup or alert box) refers to a user interface element that provides a way of notifying users and that is provided by an operating system running on a terminal (e.g., Android systems, iOS systems, etc.). Notification boxes include pull-down interactive boxes, pull-up interactive boxes, as well as interactive boxes during screen-lock (which will be discussed in detail using FIG. 2˜FIG. 4). A notification box can appear in the form of display windows or interfaces. When a notification box is displayed, it can override other display elements and appear on top of the user interface display, e.g., during screen-lock. Notification boxes are typically implemented using special functions supported by the operating system (e.g., UIAlertView in iOS® UIKit). In some embodiments, the notification box can be comprised in or displayed in connection with a notification center displayed on the screen. The notification bar or notification box can be displayed at the top of the user interface of the terminal (e.g., the notification bar or notification box can be displayed in response to a touch event or a touch and drag of an element from a top of the screen in a downward direction). As an example, for a terminal running an Android® operating system, a notification can be displayed in connection with the notification command associated with the operating system (e.g., NotificationBuilder, NotificationManager, etc.).

As used herein, dynamic information comprises information on target objects collected in real time by application programs. Examples of dynamic information include the distance between a vehicle and a passenger in taxi booking software, current weather, weather alerts, logistic information for a package (e.g., that a user ordered), location information for a taxi, location information associated with a food delivery order (e.g., a location status or location of a delivery service), etc. A target object can be a person, a vehicle, or the like. In some embodiments, the dynamic information corresponds to contextual information associated with the corresponding target object.

As used herein, a displaying object generally refers to a notification box, a floating window, image controls, text controls, a graphical user interface (GUI) widget, or the like. A displaying object can be configured to show dynamic information.

As used herein, a terminal generally refers to a device used (e.g., by a user) within a network system and used to communicate with one or more servers. According to various embodiments of the present disclosure, a terminal includes components that support communication functionality. For example, a terminal can be a smart phone, a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a smart home appliance, vehicle-mounted mobile stations, or the like. A terminal can run various operating systems.

A terminal can have various input/output modules. For example, a terminal can have a touchscreen, one or more sensors, a microphone via which sound input (e.g., speech of a user) can be input, a camera, a mouse or other external input device connected thereto, etc.

As used herein, identification information associated with a terminal (or device) can comprise, for example, an IP address associated with the confirmation device, a MAC address associated with the confirmation device, a Universal Device identifier (UDID), an International Mobile Equipment Identifier (IMEI), a Subscriber Identification Module (SIM) identifier), a phone number, an account identifier associated with the confirmation device, an account identifier associated with a user of the confirmation device, other appropriate information, or any combination thereof.

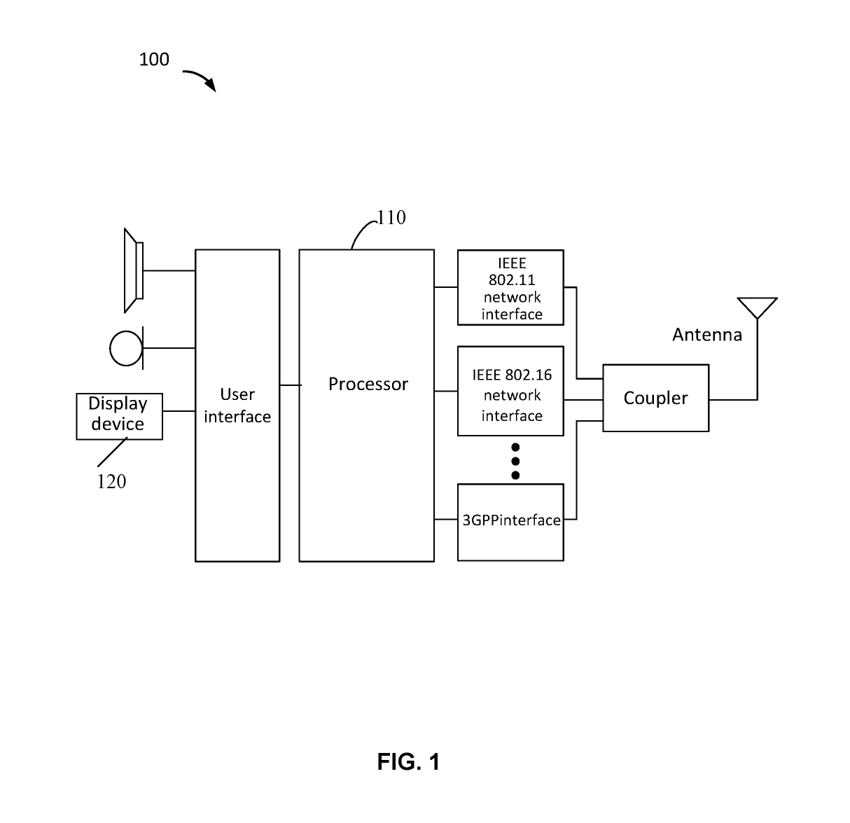

FIG. 1 is a structural diagram of a terminal according to various embodiments of the present application.

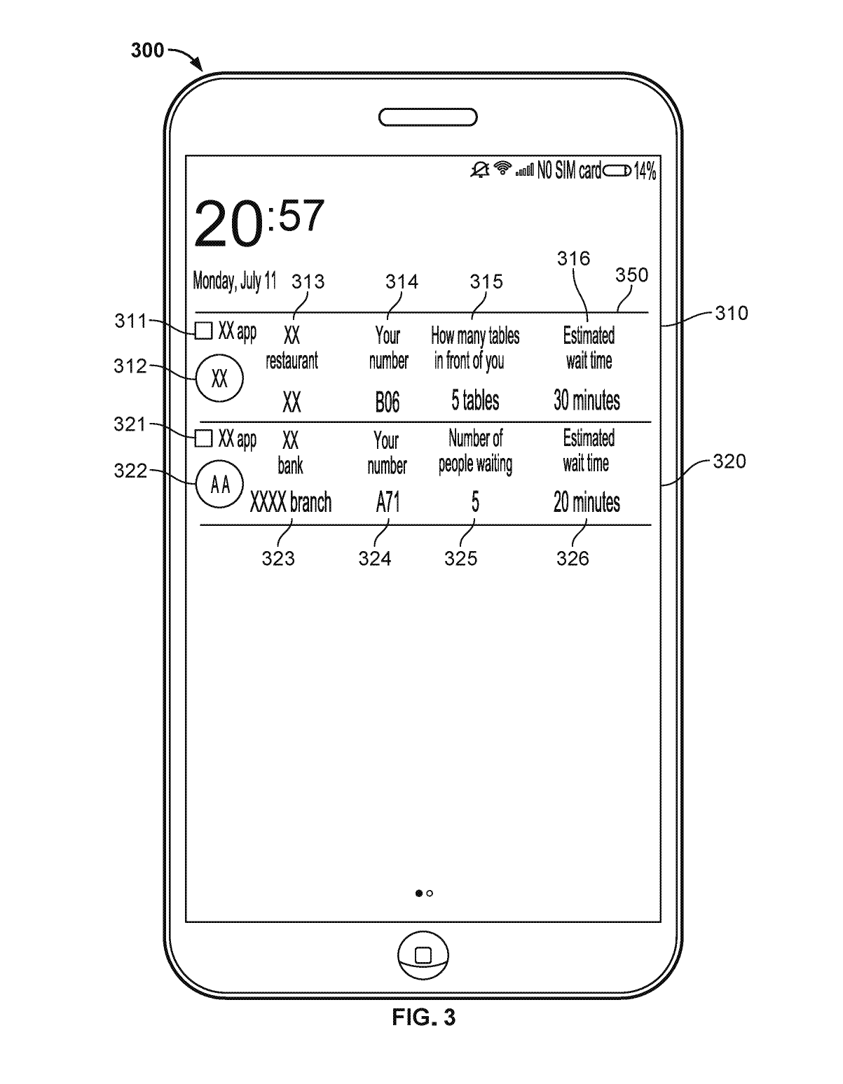

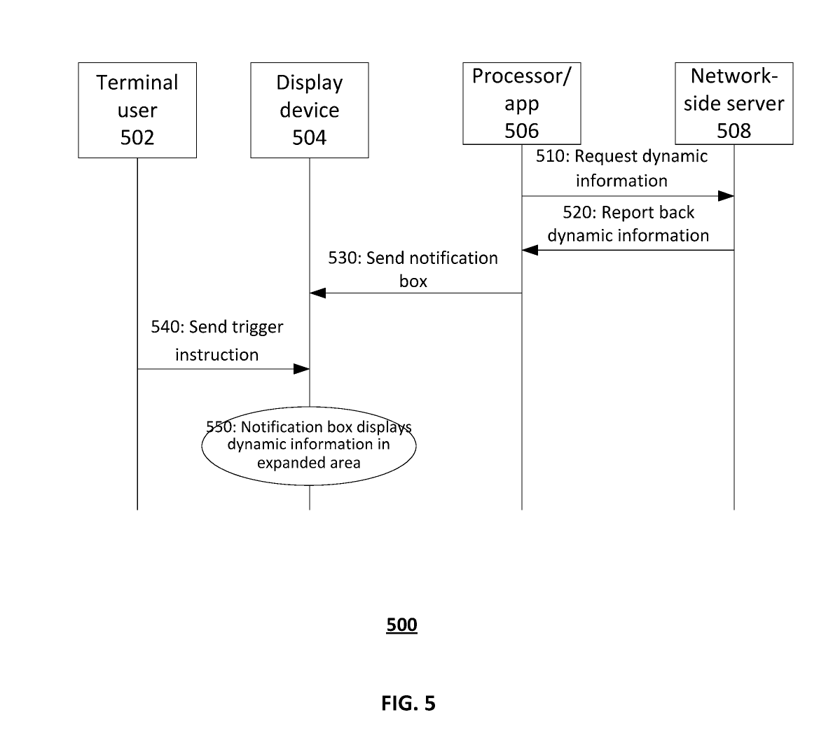

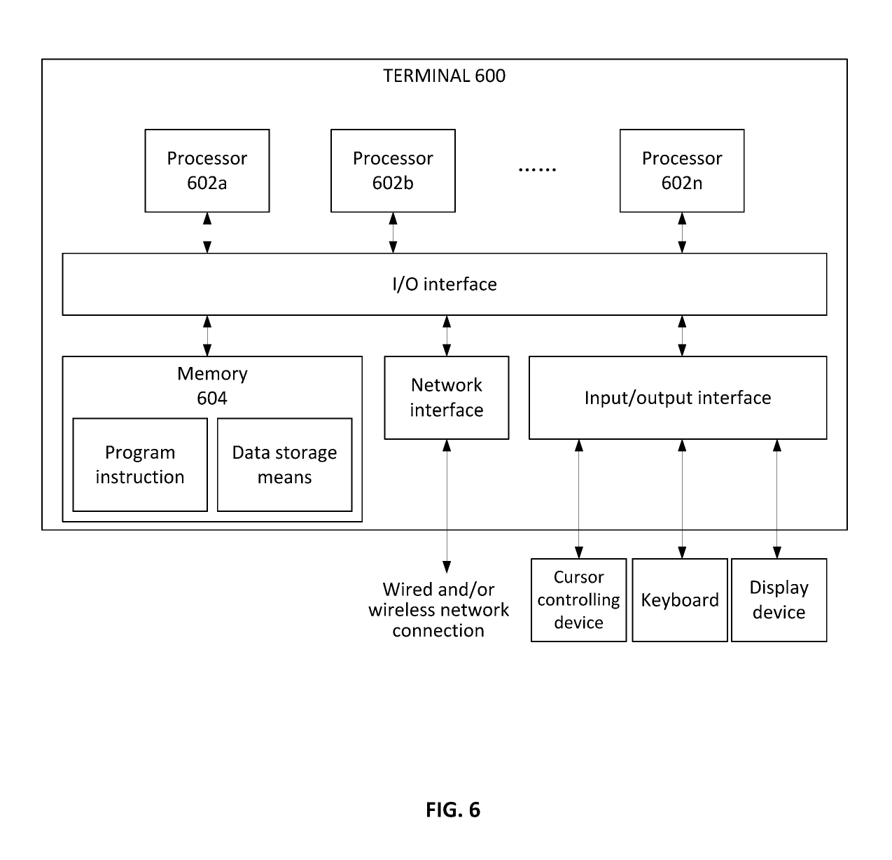

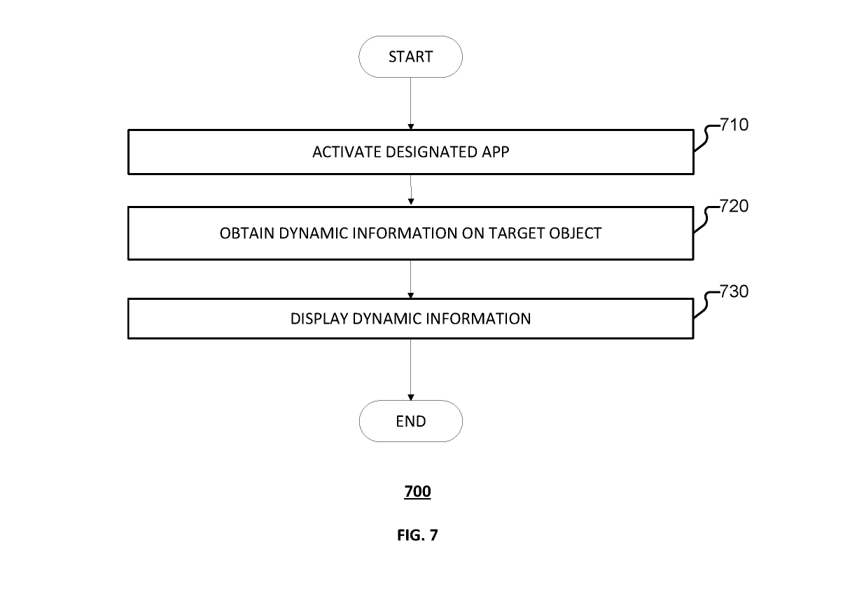

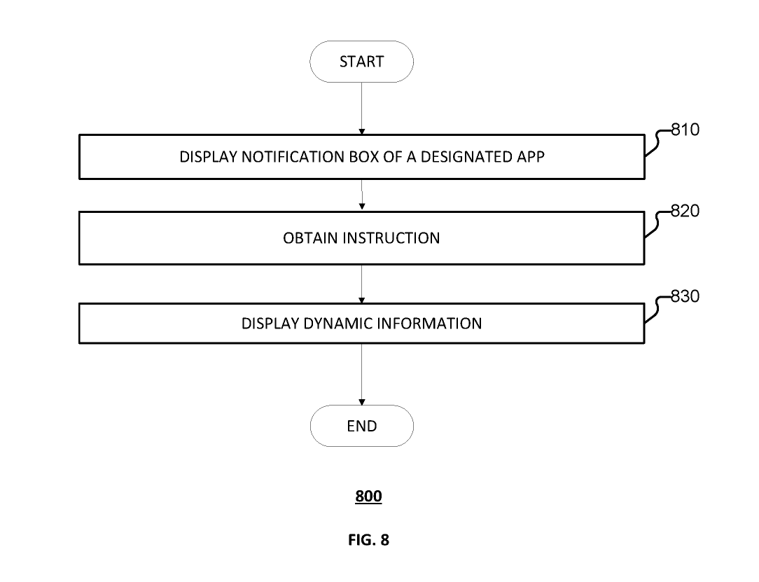

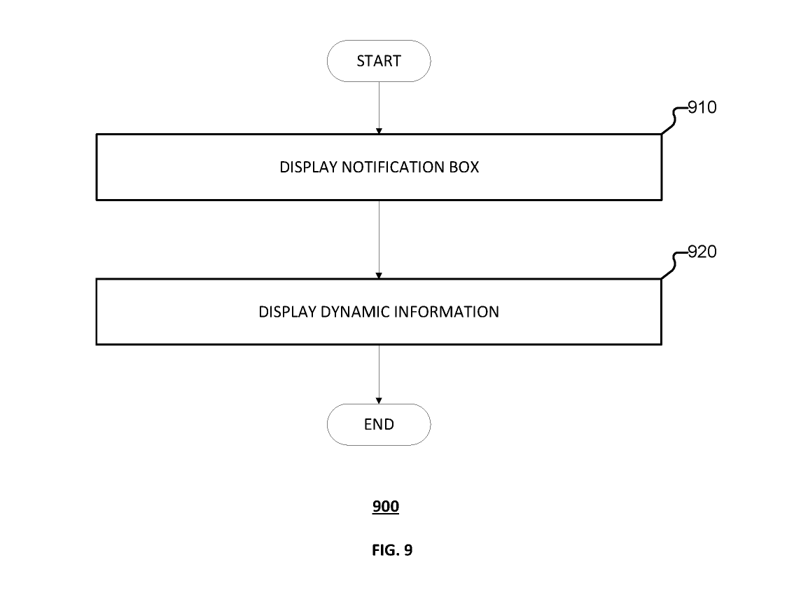

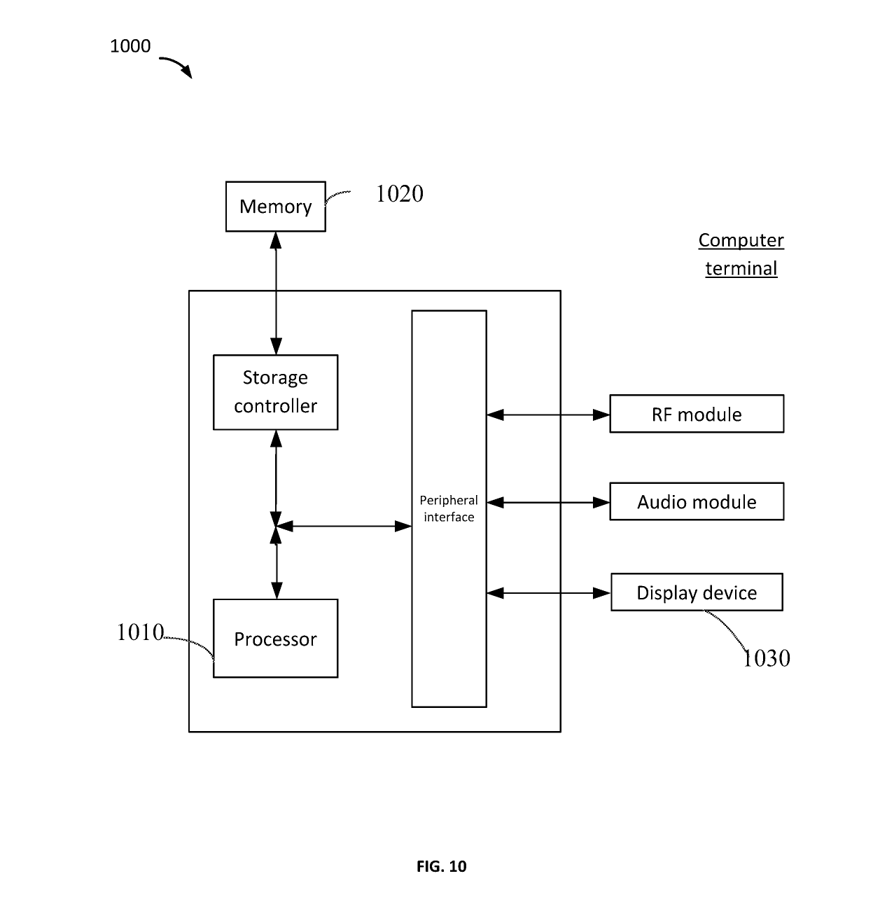

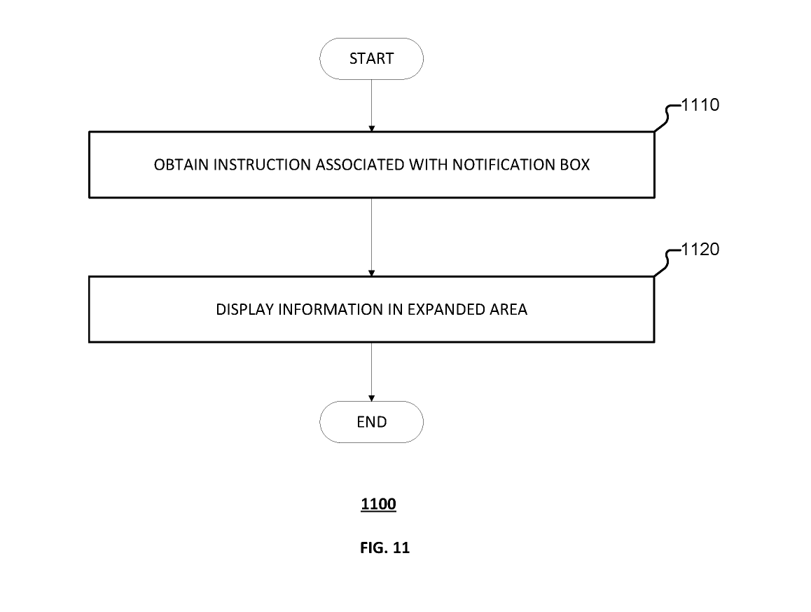

Referring to FIG. 1, terminal 100 for displaying application information is provided. Terminal 100 can implement process 500 of FIG. 5, process 700 of FIG. 7, process 800 of FIG. 8, process 900 of FIG. 9, and/or process 1100 of FIG. 11. Terminal 100 can implement notification 201 of FIG. 2 (e.g., which can be shown during screen-lock), notification 310 and/or notification 320 of FIG. 3 (e.g., which can be shown during screen-lock), and/or notification 410 of FIG. 4 (e.g., which can be shown during screen-lock). Terminal 100 can be implemented in connection with terminal 600 of FIG. 6, and/or terminal 1000 of FIG. 10.

Terminal 100 comprises processor 110 and display 120. In some embodiments, terminal 100 comprises an antenna and a communication interface such as a network interface (e.g., an IEEE 802.11 network interface, an IEEE 802.16 network interface, a 3GPP interface, a Bluetooth communication interface, etc.). Terminal 100 can comprise a coupler that couples the antenna to the communication interface or to processor 110. Terminal 100 can comprise a user interface that can be implemented in connection with processor 110, display 120, a speaker, a microphone, etc. Processor 110 can comprise one or more processors.

According to various embodiments, terminal 100 can be a smartphone, a tablet computer, a personal computer, a notebook computer, or other such smart device. For example, in the event that terminal 100 is an Android phone (e.g., running Android® as an operating system), display 120 could be an Android phone display, and processor 110 could be an Android phone processor. If terminal 100 is a personal computer, display 120 could be a personal computer display screen, and processor 110 could be a personal computer processor.

In some embodiments, processor 110 is configured to activate a designated application and to obtain (e.g., acquire) dynamic information on a target object monitored by the designated application. As used herein, dynamic information refers to information subject to change over time. Examples include location, distance, or arrival time estimation for a taxi, location information of a package that is being delivered, number of parties ahead of the user in a waiting queue, etc. Processor 110 can activate the designated application by running (e.g., executing) the designated application. Processor 110 can use the designated application in connection with obtaining the dynamic information. Target objects can comprise: one or more living objects, one or more specific areas, or both. The target object can be defined by the application, a user of the terminal (e.g., on which the application is running), etc. For example, the application can be associated with a certain target object or a certain type of target objects (e.g., an application for ordering goods online can monitor target objects associated with orders placed).

According to various embodiments, designated applications correspond to built-in applications of a terminal or applications that were subsequently installed. For example, a designated application could be a taxi booking application (such as an Uber® application) or a number-assigning application for everyday matters (also called a queueing application) (e.g., a banking application or a restaurant application that can acquire queue information). The designated application can correspond to other types of applications.

Currently, information displayed by a notification box often is rather minimal (e.g., the information displayed does not include much detail). For example, information related to the application itself is displayed in the notification box. As an illustrative example, an existing weather-forecasting application only displays weather information for the area in which the terminal is located or displays weather information for an area selected by the user. However, all such information displayed in the notification box is general-purpose information. If the terminal is in the same area as another terminal, then the information received by both will be the same. In other words, applications in the related art can only display the general-purpose information in the notification box and do not display personalized information related to the terminal user. Various embodiments use dynamic information to inform the user of the relationship between the target object and the terminal on which the designated application is installed or running.

One example of the dynamic information comprises a relative distance of the target object to terminal 100. Another example of the dynamic information comprises a queue status (e.g., a characteristic of a queue such as a wait time, an indication of a position in a queue, an indication of a size of the queue of a target object, or other queue information associated with the target object) of the area in which the target object is located. As an example, dynamic information can correspond to information associated with a location-based service (LBS) application, information within a defined area, etc. According to various embodiments, dynamic information can be determined, obtained, and/or provided to the user in real time and thus improve user experience. According to various embodiments, while the dynamic information is being displayed (e.g., by terminal 100), an icon of the designated application and/or an identifier associated with the target object can be displayed. Display of the icon of the designated application and/or the identifier associated with the target object can further improve user experience in relation to the designated application and/or the dynamic information. It is possible to display other information while the dynamic information is being displayed.

Examples of the target objects comprise a living object (such as a person or an animal) or a specific area (such as a bank, hotel, mall, stadium, store, attraction, other area of interest, etc.). Other types of target objects can be used in other embodiments. In the event that the target object comprises a specific area, the dynamic information can comprise, but is not limited to, quantity change information on specific groups or queue information on specific groups in these corresponding specific areas. In the event that the target object comprises a living object, the dynamic information can comprise a location of the target object (e.g., an individual, etc.) such as a location of a delivery person, a status of the target object (e.g., information associated with whether a user is online, offline, logged in, etc., information associated with a status update of a user), a relative location or distance of the target object to another location or object (e.g., the terminal), etc. In some embodiments, the specific group is a group that the terminal user wishes to participate in or is already participating in. According to various embodiments, a user registers with or otherwise participates with a specific group.

The ways in which dynamic information is displayed are explained in detail below according to the different types of applications or target objects.

In this example, the dynamic information comprises information associated with a relative distance of terminal 100 to a target object. In the event that dynamic information includes the relative distance of a terminal to a target object, the relative distance is displayed in the notification box and the motion track of the target object (e.g., the moving path of the target object as it travels) is displayed on an electronic map. For example, a movement of terminal 100 in relation to the target object can be displayed on an electronic map. As another example, a projected movement of terminal 100 in relation to the target object can be displayed on an electronic map. The movement of the terminal, or the projected movement of terminal 100, in relation to the target object can be determined based at least in part on a location of terminal 100, a speed of terminal 100, a location of the target object, a speed of the target object, etc. The location and/or speed of terminal 100 can be determined based on a location device of the terminal (e.g., a GPS device operatively connected to terminal 100, etc.), a location of one or more networks to which terminal 100 connects over a period of time, etc. As an illustrative example, various embodiments can be applied to taxi booking software or to express delivery software, in which case the location, as well as the distance from the terminal user, of the taxi or of the courier could be displayed in real time in the notification box. In some embodiments, the electronic map corresponds to a map locally drawn by the designated application with coordinate information sent by the network-side server. Other implementations of an electronic map can be used. For example, the designated application can make a call via an API to a mapping application or a library to obtain information associated with the map and/or the present information on the electronic map.

FIG. 2 is a diagram of a screen including a notification box of an optional taxi booking application according to various embodiments of the present application.

Referring to FIG. 2, screen 200 including notification 201 for displaying application information is provided. Notification 201 can be provided by terminal 100 of FIG. 1 (e.g., terminal 100 can display notification 210 during a screen-lock), and implemented in connection with process 500 of FIG. 5, process 700 of FIG. 7, terminal 600 of FIG. 6, process 800 of FIG. 8, process 900 of FIG. 9, terminal 1000 of FIG. 10, and/or process 1100 of FIG. 11. People having ordinary skill in the art will comprehend that a notification box, a floating window, image controls, text controls, or a graphical user interface (GUI) widget is able to be used to show dynamic information.

According to various embodiments, notification 201 is presented (e.g., displayed) by an application. As an illustrative example, the application can display information associated with the application and contextual information associated with the user associated with (e.g., logged into) the application. As illustrated in FIG. 2, the application provides notification 201 which comprises displays driver information 202, vehicle license number, the relative distance (e.g., 1.2 km) from the passenger 206, estimated time of arrival at passenger location 208, and the positions of the vehicle 212 and the passenger 214 on an electronic map 210.

In this example, notification 201 is presented (e.g., displayed) in notification box 250 during screen lock. Notification box 250 can be presented on screen 200. In other embodiments, notification box 250 can comprise one or more notifications. According to another embodiment of the present disclosure, notification 201 can be presented in a floating window. As used herein, a notification box is used as an example of an element which presents dynamic information. The one or more notifications in notification box 250 can be associated with one or more applications. For example, a first application can display in notification box 250 a first notification associated with the first application, and a second application can simultaneously (or contemporaneously) display in notification box 250 a second notification associated with the second application.

Notification 201 (or notification box 250 in which notification 201 is displayed) can be displayed on a user interface screen that is different from the native interface of the application associated with notification 201. For example, notification 201 can be displayed on a home screen of a terminal, in a drop-down menu presented on a terminal (e.g., in response to a predefined input to the terminal such as a downward swipe from the top of the screen), as a pop-up on a currently displayed screen, on a lock screen that is displayed when the terminal is locked, etc. Notification 201 can be displayed on various other screens or interfaces displayed by the terminal. Notification 201 can be displayed for a predefined period of time (e.g., starting with an event such as receiving a message sent by another device, receiving a status update of an activity from the operating system or the application, reaching a specific time, etc., that causes or otherwise invokes notification 201 to be displayed).

As an example, notification 201 can be invoked or caused to be presented (e.g., displayed) by a periodic (or push) update to application data when the terminal is in an inactive or locked mode (e.g., the notification can be invoked during a screen lock of the terminal). As another example, notification 201 can be invoked or caused to be presented in connection with a drop-down from the top of the screen of the terminal. A user can select the notification 201 from a drop down or other similar control. Other controls for invoking notification 201 or otherwise causing notification 201 to be displayed can be used.

Notification 201 can be invoked or caused to be displayed during normal operation (e.g., of the terminal), when the terminal (e.g., the operating system) is operating in an inactive state, when the terminal (e.g., the operating system) is operating in a screen lock state, etc. As an example, when the terminal (e.g., the operating system) is operating in a screen lock state, notification 201 (e.g., the notification box 250 comprising notification 201) can be triggered by periodic updates to application data. As another example, when the terminal (e.g., the operating system) is operating during normal operation, notification 201 (e.g., the notification box 250 comprising notification 201) can be triggered by an input associated with a drop-down of a notification menu (or notification box) from a top of the screen of the terminal.

FIG. 3 is a diagram of a user interface screen including a notification box of an optional restaurant and banking application according to an embodiment of the present application.

Referring to FIG. 3, screen 300 including notification 310 and notification 320 for displaying application information is provided. Notification 310 and/or notification 320 can be provided by terminal 100 of FIG. 1 (e.g., terminal 100 can display notification 310 and/or notification 320 during a screen-lock), and implemented in connection with process 500 of FIG. 5, process 700 of FIG. 7, terminal 600 of FIG. 6, process 800 of FIG. 8, process 900 of FIG. 9, terminal 1000 of FIG. 10, and/or process 1100 of FIG. 11. People having ordinary skill in the art will comprehend that a notification box, a floating window, image controls, text controls, or a GUI widget is able to be used to show dynamic information.

According to various embodiments, notification 310 and/or notification 320 is presented (e.g., displayed) by an application. Notification 310 and notification 320 can be deemed a single notification or separate notifications (e.g., presented on screen 300). As an illustrative example, the application can display information associated with the application and contextual information associated with the user associated with (e.g., logged into) the application. As illustrated in FIG. 3, notification 310 comprises an indication 311 of the associated application (e.g., “XX Restaurant/XX branch”). The application obtains queue status information from a server that is associated with the restaurant and is used to maintain queue information. Notification 310 displays the icon for the application 312, the name of the restaurant 313, the number associated with the user (e.g., a number assigned by the restaurant) 314, the number of tables ahead of the user (or the number of people in line ahead of the user) 315, and the estimated wait time 316. In other embodiments, notification 310 can be configured by the user to display more or less information than what is shown. Similarly, notification 320 can comprise indication 321 of another associated application (e.g., a bank queue management application), and/or can display the icon for the application 322, the name of the bank 323, the number associated with the user (e.g., a number assigned by the bank) 324, the number of people in line ahead of the user (of the terminal displaying screen 300) 325, and the estimated wait time 326.

In some embodiments, notification 310 and/or notification 320 is presented (e.g., displayed) in notification box 350. Notification box 350 can be presented on screen 300.

Notification 310 can be invoked or caused to be displayed during normal operation (e.g., of the terminal), when the terminal (e.g., the operating system) is operating in an inactive state, when the terminal (e.g., the operating system) is operating in a screen lock state, etc. As an example, when the terminal (e.g., the operating system) is operating in a screen lock state, notification 310 (e.g., the notification box 350 comprising notification 310) can be triggered by periodic updates to application data. As another example, when the terminal (e.g., the operating system) is operating during normal operation, notification 310 (e.g., the notification box 350 comprising notification 310) can be triggered by an input associated with a drop-down of a notification menu (or notification box) from a top of the screen of the terminal.

According to various embodiments, an application that displays dynamic information can be associated with a restaurant or the like. In some embodiments, a notification associated with an application associated with a restaurant can display similar content (e.g., as dynamic information) about restaurants as the content displayed in notification 310 and notification 320. According to various embodiments, the notification box can simultaneously display dynamic information for multiple applications. The specific number can be determined according to the actual situation.

FIG. 4 is a diagram of a screen including a notification box of an express delivery application according to an embodiment of the present application.

Referring to FIG. 4, screen 400 including notification 410 for displaying application information is provided. Notification 410 can be provided by terminal 100 of FIG. 1 (e.g., terminal 100 can display notification 410 during a screen-lock), and implemented in connection with process 500 of FIG. 5, process 700 of FIG. 7, terminal 600 of FIG. 6, process 800 of FIG. 8, process 900 of FIG. 9, terminal 1000 of FIG. 10, and/or process 1100 of FIG. 11. People having ordinary skill in the art will comprehend that a notification box, a floating window, image controls, text controls, or a GUI widget is able to be used to show dynamic information.

In this example, notification 410 is presented (e.g., displayed) in notification box 450. Notification box 450 is presented on screen 400. Notification box 450 can comprise one or more notifications. The one or more notifications in notification box 450 can be associated with one or more applications. For example, a first application can display in notification box 450 a first notification associated with the first application, and a second application can simultaneously (or contemporaneously) display in notification box 450 a second notification associated with the second application.

Notification 410 (or notification box 450 in which notification 410 is displayed) can be displayed on a screen that is different from the native interface of the application associated with notification 410. For example, notification 410 can be displayed on a home screen, in a drop-down menu presented on a terminal (e.g., in response to a predefined input to the terminal such as a downward swipe from the top of the screen), as a pop-up on a currently displayed screen, on a screen displayed when the terminal is locked, etc. Notification 410 can be displayed on various other screens or interfaces displayed by the terminal. Notification 410 can be displayed for a predefined period of time (e.g., beginning upon an event such as an event that causes or otherwise invokes notification 410 to be displayed).

Notification 410 can be invoked or caused to be displayed during normal operation (e.g., of the terminal), when the terminal (e.g., the operating system) is operating in an inactive state, when the terminal (e.g., the operating system) is operating in a screen lock state, etc. As an example, when the terminal (e.g., the operating system) is operating in a screen lock state, notification 410 (e.g., the notification box 450 comprising notification 410) can be triggered by periodic updates to application data. As another example, when the terminal (e.g., the operating system) is operating during normal operation, notification 410 (e.g., the notification box 450 comprising notification 410) can be triggered by an input associated with a drop-down of a notification menu (or notification box) from a top of the screen of the terminal.

As illustrated in FIG. 4, notification box 450 can present (e.g., display) notification 410. Notification 410 can display an indication 411 of the application associated with notification 410, the name or identifier of the express delivery company 412 (or company associated with the application), the tracking number 413 (e.g., associated with a package corresponding to the user of the application running on the terminal displaying screen 400), an intermediate location at which the express parcel has arrived 414, an estimated time of delivery (e.g., to the user) 415, and the transshipment facilities through which the express parcel passes 416. For example, the transshipment facilities through which the express parcel passes 416 can correspond to a route of the package.

According to various embodiments, dynamic information in connection with display of a notification box can be obtained in various ways. In some embodiments, the dynamic information is pre-stored by the designated application as updates for the dynamic information become available. The dynamic information can be stored locally at a terminal running the designated application or remotely on a storage that is accessible (e.g., via a network) to the designated application. The dynamic information can be obtained from the storage by the designated application. In some embodiments, the dynamic information is obtained from a server. For example, the designated application can obtain the dynamic information from the server. In some embodiments, the dynamic information is obtained in connection with the server providing a software as a service (SaaS) to the designated application (e.g., the terminal running the designated application). A request message can be sent to the designated application. In some embodiments, the request message sent to the designated application is used to trigger the designated application to request the dynamic information from a network-side server. The request message can be sent to the designated application in response to an input to a terminal running the designated application. For example, an input by a user of the terminal can invoke the designated application to request the dynamic information from a server. In response to the designated application requesting the dynamic information from a server, the dynamic information can be obtained from the server. As an example, the server can send the dynamic information to the designated application (or the terminal running the designated application). As another example, the designated application can retrieve the dynamic information from the server.

According to various embodiments, the designated application can invoke the request message (or instruction) to be sent, or otherwise cause itself to trigger the display of dynamic information. For example, an update to, or reception of new, dynamic information can invoke the designated application to display the dynamic information. The designated application can invoke the request message (or instruction) to be sent to another application associated with the display of notifications for display of the notification (e.g., notification 410).

According to various embodiments, a process of the designated application obtaining the dynamic information from storage can increase the display rate of the dynamic information. For example, the designated application can acquire the dynamic information in advance (e.g., acquire the designated application from the network side). When the dynamic information is updated, the designated application is notified of the update and re-acquires the dynamic information. In the event that the designated application is to use the dynamic information (e.g., display the dynamic information or use the dynamic information to provide the user with information), the designated application extracts the dynamic information from a buffer used to store the dynamic information. In some embodiments, the designated application is configured to acquire the dynamic information periodically (e.g., every two minutes or every two hours). For example, a user or administrator can configure the frequency according to which the designated application obtains (or attempts to obtain) the dynamic information. Although the obtaining of dynamic information in response to a request message being sent to the designated application can have a lower refresh rate than the process of the designated application obtaining the dynamic information from storage, the former technique can ensure that the dynamic information is the latest (e.g., most current) dynamic information. For example, the obtaining of dynamic information in response to a request message being sent to the designated application obtains dynamic information when the dynamic information is to be used by the designated application.

Returning to FIG. 1, display 120 is configured to display dynamic information in a notification box of the terminal. For example, the display 120 displays the notification box on a screen (e.g., a user interface of the terminal), and the notification box can comprise dynamic information or information obtained by using the dynamic information. According to various embodiments, the dynamic information includes multiple pieces of information. In the event that the dynamic information includes multiple pieces of information, the notification box can dynamically display the multiple pieces of information in a loop (e.g., displaying the multiple pieces of information according to some sequence, then repeating the sequential display). For example, the quantity of the dynamic information can be obtained (e.g., determined); in the event that the quantity of dynamic information is greater than a preset threshold value, the multiple pieces of information can be displayed in a loop. The multiple pieces of information can be displayed according to preset priority levels respectively associated with the multiple pieces of information. For example, the multiple pieces of information can be displayed in a loop according to preset priority levels respectively associated with the multiple pieces of information. The position, order, and/or time for which the multiple pieces of information are displayed in the loop can be determined according to the preset priority levels respectively associated with the multiple pieces of information. In some embodiments, one or more pieces of the dynamic information are displayed at a time during loop display of the multiple pieces of information.

The preset priority levels can be configurable by a user or an administrator. In some embodiments, the preset priority levels can be set according to user preferences (e.g., the terminal can monitor usage of a set of applications or a type of notifications and adjust, or suggest to the user an adjustment, to the corresponding priority levels). In some embodiments, in the event multiple notifications from an application are to be displayed, the corresponding priority (e.g., priority levels) can be set according to the latest generated notification or corresponding time associated with the information comprised in the notification. For example, the latest notification can have a higher priority than an earlier notification. Priority levels associated with multiple notifications associated with a same application can be set according to first in first out (FIFO). The terminal can store the preset priority levels locally.

In some embodiments, in the event that the quantity of dynamic information is less than (or equal to) the preset threshold value, all of the multiple pieces of information can be displayed simultaneously in the notification box. In some embodiments, only those pieces of information associated with a priority level higher than a preset priority threshold are displayed. The preset priority threshold can be configurable by a user or an administrator. In some embodiments, the preset priority threshold can be set according to user preferences (e.g., the terminal can monitor usage of a set of applications or a type of notifications and adjust, or suggest to the user an adjustment, to the corresponding priority threshold).

FIG. 5 is a time sequence diagram of a process for displaying application information according to various embodiments of the present application.

Referring to FIG. 5, a process for displaying application information is provided. Process 500 can be implemented by terminal 100 of FIG. 1, terminal 600 of FIG. 6, and/or terminal 1000 of FIG. 10. Process 500 can implement notification 201 of FIG. 2 (e.g., which can be shown during screen-lock), notification 310 and/or notification 320 of FIG. 3 (e.g., which can be shown during screen-lock), and/or notification 410 of FIG. 4 (e.g., which can be shown during screen-lock).

At 510, dynamic information is requested. In this example, the dynamic information is requested by processor and/or designated application 506. Processor and/or designated application 506 can be associated with a terminal. For example, the terminal can include the processor and/or run the designated application. The request for dynamic information can be sent to a network side server 508 (also referred to herein as server 508). In this example, an application running on a terminal processor requests dynamic information about the monitored target object from a network-side server. In some embodiments, the request for dynamic information sent to server 508 is sent periodically according to a preset cycle (e.g., hourly, daily, etc.). In some embodiments, the dynamic information is requested in response to the designated application indicating that information is to be displayed as a notification. For example, the application can determine that an event occurred and that the occurrence of such an event is to invoke display of information in the form of a notification.

In some embodiments, server 508 is configured to push dynamic information periodically to the application. In the event that server 508 is configured to push dynamic information periodically to the application, 510 could be omitted.

At 520, dynamic information is obtained. Processor and/or designated application 506 can obtain the dynamic information. For example, processor and/or designated application 506 can obtain the dynamic information from server 508. In some embodiments, server 508 sends the dynamic information (or a pointer associated with a location at which the dynamic information can be obtained) to processor and/or designated application 506. In some embodiments, server 508 sends the dynamic information to processor and/or designated application 506 in response to the designated information being requested.

At 530, information associated with a notification box is communicated. The information associated with a notification box can be the notification box to be displayed or information from which the notification box to be displayed is generated. In some embodiments, the processor and/or designated application 506 sends the information associated with a notification box to display 504. The display 504 corresponds to a display for the terminal with which processor and/or designated application 506 is associated (e.g., an LCD/LED display, a separate display terminal, etc.). The information associated with the notification box (e.g., the notification box) can be sent to a display interface to be displayed on display 504. According to various embodiments, display 504 displays information associated with a notification box. For example, display 504 can display a notification box on the display interface. In some embodiments, display 504 is a touchscreen. In some embodiments, the notification box is generated by processor and/or application 506. In some embodiments, the notification box is generated by display 504.

At 540, a trigger instruction is communicated. In some embodiments, a trigger instruction is generated in response to an input to display 504 (e.g., if display is a touch screen) or to an input to a terminal. The trigger instruction can be generated in response to an input by terminal user 402. The trigger instruction can be communicated in response to an input to the notification box displayed by the display 504.

At 550, in response to the trigger instruction being communicated, an action in relation to the notification box is performed based on the trigger instruction. For example, in response to the trigger instruction being obtained by display 504, and/or processor and/or designated application 506, the dynamic information is displayed in an expanded area of the notification box. The expanded area can correspond to an area on the screen that is enlarged relative to the notification box and includes dynamic information. For example, an initial alert can be displayed in which a subset of dynamic information is displayed; and upon selection of the initial alert or other function to expand the dynamic information, the expanded area can be invoked in which a larger set of dynamic information (e.g., more detailed dynamic information) is provided. The expanded area can be displayed in response to an input to display an area for notifications. For example, in response to a downward swipe gesture on a touch screen, the terminal can display the expanded area. In some embodiments, in response to the trigger instruction being obtained by display 504, and/or processor and/or designated application 506, a designated application is executed. For example, in response to the trigger instruction, the terminal can switch context to the designated application. The designated application can display the dynamic information in more detail. In some embodiments, in response to predefined instruction (e.g., corresponding to a disregard or ignore feature), the notification box can be removed from the display.

FIG. 6 is a structural diagram of a computer terminal according to various embodiments of the present application.

Referring to FIG. 6, terminal 600 for displaying application information is provided. Terminal 600 can implement process 500 of FIG. 5, process 700 of FIG. 7, process 800 of FIG. 8, process 900 of FIG. 9, and/or process 1100 of FIG. 11. Terminal 600 can implement notification 201 of FIG. 2 (e.g., which can be shown during screen-lock), notification 310 and/or notification 320 of FIG. 3 (e.g., which can be shown during screen-lock), and/or notification 410 of FIG. 4 (e.g., which can be shown during screen-lock). Terminal 600 can be implemented in connection with terminal 100 of FIG. 1, and/or terminal 1000 of FIG. 10.

Terminal 600 comprises one or more (indicated by 602a, 602b, . . . , 602n in the drawing) processors 602 (the processors 602 may include, but are not limited to, processing means such as microprocessors (MCU) or programmable logic devices (FPGA)), memory 604 configured to store data, and a network interface configured to perform communication functions. In addition, terminal 600 may further comprise: a display, input/output interfaces (I/O interfaces), a universal serial bus (USB) port (may be included as one port among ports serving as I/O interfaces), a network interface, a power supply, and/or a camera. Persons with ordinary skill in the art may understand that the structures shown in FIG. 6 are merely illustrative and do not limit the structures of the aforesaid electronic device. For example, terminal 600 may further comprise more or fewer components than shown in FIG. 6 or may have a configuration that differs from the one shown in FIG. 6.

Please note that the aforesaid one or more processors 602 (indicated by 602a, 602b, . . . , 602n in the drawing) and/or other data processing circuits may generally be referred to as “data processing circuits” in this document. The data processing circuits can fully or partially be embodied as software, hardware, firmware, or any combination. In addition, a data processing circuit can be a single, independent processing module or any of the other components that are fully or partially integrated with terminal 600. For example, the data processing circuit can serve as a processor control (e.g., selection of the interface-connected variable resistance terminal path).

Memory 604 may be used to store application programs and modules of the application software (e.g., a program instruction/data storage means corresponding to an application information displaying process according to various embodiments of the present application). By running software programs and modules stored in memory 604, processors 602 (indicated by 602a, 602b, . . . , 602n in the drawing) execute various function applications and data processing (i.e., implement the application displaying detecting process for the application programs described above). Memory 604 may comprise high-speed random access memory. Memory 604 may further comprise non-volatile memory, such as one or more magnetic storage devices, flash memory, or other non-volatile solid-state memory. In some embodiments, memory 604 may further comprise memory that is remotely disposed relative to processors 602 (indicated by 602a, 602b, . . . , 602n in the drawing). Such remote memory may be connected to terminal 600 via a network. Examples of the aforesaid network comprise but are not limited to the Internet, corporate intranets, local area networks, mobile communication networks, and combinations thereof.

According to various embodiments, terminal 600 may comprise a transmitting device or communication device. The transmitting device or communication device is configured to receive and/or send data via a network. The transmitting device or communication device can use a network interface in connection with the sending/receiving of data via a network. Specific examples of the network may comprise wireless networks provided by communication suppliers for terminal 600. In some embodiments, the transmitting device or communication device comprises a network interface controller (NIC), which can connect to other networks via a base station and thereby communicate with the Internet. In an example, the transmitting device or communication device may be a radio frequency (RF) module, which is for communicating with the Internet wirelessly.

In some embodiments, terminal 600 comprises a display. The display can, for example, be a touch-screen liquid crystal display (LCD). This touch-screen LCD can enable the user to interact with the user interface of terminal 600.

FIG. 7 is a diagram of a process for displaying application information according to various embodiments of the present application.

Referring to FIG. 7, process 700 for displaying application information is provided. Process 700 can be implemented by terminal 100 of FIG. 1, terminal 600 of FIG. 6, and/or terminal 1000 of FIG. 10. Process 700 can implement notification 201 of FIG. 2 (e.g., which can be shown during screen-lock), notification 310 and/or notification 320 of FIG. 3 (e.g., which can be shown during screen-lock), and/or notification 410 of FIG. 4 (e.g., which can be shown during screen-lock).

At 710, a designated application is activated. Activation of the designated application can include executing or running the designated application on a terminal. As an example, the designated application can be activated in response to an input to the terminal on which the designated application is installed to launch the designated application or, if the designated application is already launched but running in the background, to switch the operating system to execute the designated application in the foreground. As another example, an operating system of the terminal on which the designated application is installed or running can activate the designated application in response to a predefined event (e.g., in the event that the designated application is activated periodically, the predefined event can be the expiration of a timer, etc.).

At 720, dynamic information is obtained. The dynamic information can be obtained by the designated application. In some embodiments, the designated application can obtain the dynamic information from a storage (e.g., a storage local to the terminal on which the designated application is installed or running). In some embodiments, the designated application obtains the dynamic information by querying a server associated with the designated application or target object, or by otherwise sending a request to the server. The designated application can obtain the dynamic information in response to the designated application being activated. The dynamic information can be associated with a target object. In the event that the dynamic information is associated with a target object, obtaining the dynamic information can include querying a storage or server using the target object or identifier associated therewith, or by including the target object or identifier associated therewith in a request. The dynamic information can be obtained by the designated application based at least in part on the target object monitored by the designated application. In some embodiments, the obtaining of the dynamic information comprises acquiring from the designated application the dynamic information pre-stored by the designated application. In some embodiments, the obtaining of the dynamic information comprises sending a request message to the designated application, the request message corresponding to a triggering of the designated application to request the dynamic information from a network-side server, and receiving the dynamic information by the designated application from the network-side server.

In some embodiments, the dynamic information is associated with the relationship (e.g., in relation to distance, time, service being provided, etc.) between the target object and the terminal on which the designated application is installed or running. For example, the dynamic information can be an estimated time of arrival of the target object (e.g., to the terminal), or estimated time of arrival of the terminal (e.g., to the target object). As another example, the dynamic information can be a wait time associated with one or more services at the target object or a target service. As another example, the dynamic information can include an amount of time until the target object closes (e.g., if the target object is a restaurant or other location at which a service is performed), etc. As another example, the dynamic information can provide information of one or more services being provided at the target object; the dynamic information can include an availability of one or more services, a current price, etc.

The dynamic information can comprise contextual information associated with a user of the designated application (e.g., a user or account logged in to the designated application) or with the terminal on which the designated application is running. In some embodiments, the dynamic information includes at least one of the following: the relative distance of the target object to the terminal or the queue status of the area in which the target object is located.

In some embodiments, an icon of the designated application, an identifier for the target object, etc. can be displayed while the dynamic information is being displayed. The dynamic information can be displayed in a notification box (e.g., on a user interface displayed by the terminal).

At 730, dynamic information is displayed. In some embodiments, the dynamic information is displayed in a notification box displayed on the terminal. In some embodiments, in the event that the dynamic information includes relative location information and/or relative distance, the relative distance is displayed in the notification box or the motion track (or projected motion track) of the target object is displayed on an electronic map, or both.

In some embodiments, in the event that the dynamic information includes queue information (e.g., information relating to a context of a queue associated with the target object), the queue information is displayed (e.g., in the notification box), including the queue number of the target object in the queue, the number of persons queued ahead of the queue number, the wait time, etc. As an example, the dynamic information can comprise queue information associated with a user waiting for service at a restaurant.

In some embodiments, in the event that the dynamic information includes multiple pieces of information, the displaying of the dynamic information (e.g., in notification boxes of the terminal) includes: acquiring the quantity of the dynamic information; and determining whether the quantity of the dynamic information is greater than a preset threshold, and in the event that the quantity of the dynamic information is greater than a preset threshold value, displaying the multiple pieces of information (e.g., in the notification box). In the event that the quantity of the dynamic information is greater than a preset threshold value, the multiple pieces of information can be displayed in a loop according to preset priority levels. In some embodiments, one or more pieces of the dynamic information are displayed at a time during loop display of the multiple pieces of information.

Please note that all the process embodiments described above have been presented as a series of a combination of actions in order to simplify the descriptions. However, persons skilled in the art should know that the present application is not limited by the action sequences that are described, for some of the steps may make use of another sequence or be implemented simultaneously in accordance with the present application. Furthermore, persons skilled in the art should also know that the embodiments described in the Description are preferred embodiments and that the actions and modules involved therein are not necessarily required by the present application.

Through descriptions of the above implementations, persons skilled in the art can clearly understand that processes based on the aforesaid embodiment may be realized through software with the necessary general-use hardware platform. Of course, hardware may also be used, but in many cases the former is the preferred implementation. Based on such an understanding, the technical solution of the present application, whether intrinsically or with respect to portions that contribute to the prior art, is realizable in the form of software products. These computer software products can be stored on storage media (such as ROM/RAM, magnetic disks, and optical disks) and include a certain number of instructions used to cause a piece of terminal equipment (which could be a mobile telephone, a computer, a server, or network equipment) to execute the processes described in the embodiments of the present application.

In some embodiments, a terminal for displaying the application information includes: a processor configured to receive a trigger instruction directed at the aforesaid notification box, and a display screen configured to display the notification or notification box comprising the notification of a designated application in the current display interface of the terminal, and to display dynamic information of the designated application in an expanded area of the notification box in response to being triggered by the trigger instruction. The notification or notification box comprising the notification can be displayed in response to an input such as a downward gesture on a touch screen from the top of the screen to expand an area in which notifications can be presented.

FIG. 8 is a diagram of a process for displaying application information according to various embodiments of the present application.

Referring to FIG. 8, process 800 for displaying application information is provided. Process 800 can be implemented by terminal 100 of FIG. 1, terminal 600 of FIG. 6, and/or terminal 1000 of FIG. 10. Process 800 can implement notification 201 of FIG. 2, notification 310 and/or notification 320 of FIG. 3, and/or notification 410 of FIG. 4.

At 810, a notification is displayed. As a non-limiting example, the notification can be displayed in a notification box. In some embodiments, the notification associated with the designated application is displayed. The notification can be displayed in a notification box associated with the designated application or in an area of the screen in which notifications from one or more applications are displayed. In some embodiments, the notification box is displayed at a part of a user interface displayed by a terminal in which notifications are presented to a user of the terminal. The notification box can be displayed in the current display interface of the terminal. The notification comprises dynamic information. The dynamic information can inform the user of the relationship between the target object and the terminal on which the designated application is installed or running.

One example of the dynamic information comprises a relative distance of the target object to the terminal. Another example of the dynamic information comprises a queue status (e.g., a characteristic of a queue such as a wait time, an indication of a position in a queue, an indication of a size of the queue of a target object, or other queue information associated with the target object) of the area in which the target object is located. As an example, dynamic information can correspond to information associated with a location-based service (LBS) application, information within a defined area, etc. According to various embodiments, dynamic information can be determined, obtained, and/or provided to the user, in real time and thus improve user experience. According to various embodiments, while the dynamic information is being displayed (e.g., by the terminal), an icon of the designated application and/or an identifier associated with the target object can be displayed. Display of the icon of the designed application and/or the identifier associated with the target object can further improve user experience in relation to the designated application and/or the dynamic information. It is possible to display other information while the dynamic information is being displayed.

At 820, an instruction is obtained. In some embodiments, the instruction corresponds to a triggering instruction associated with the notification or a notification box in which the notification is displayed. The instruction can be obtained in response to an input to the terminal. For example, in response to an input by a user to a user interface of the terminal, the instruction can be generated. The input can correspond to a selection via a touch input to a touch screen display of the terminal. For example, the input can correspond to a selection or other input to, or otherwise associated with the notification or a notification box in which the notification is displayed.

At 830, dynamic information is displayed. In some embodiments, the dynamic information is displayed in response to the instruction being obtained. The dynamic information can be displayed in connection with the notification (e.g., in the notification box). In some embodiments, an expanded area in which the dynamic information is displayed is generated. For example, the expanded area can correspond to an expanded area of the notification box. In some embodiments, the dynamic information is displayed on a screen of the designated application.

In some embodiments, the dynamic information is associated with the relationship (e.g., in relation to distance, time, service being provided, etc.) between the target object and the terminal on which the designated application is installed or running.

The dynamic information can comprise contextual information associated with a user of the designated application (e.g., a user or account logged in to the designated application) or with the terminal on which the designated application is running. In some embodiments, the dynamic information includes at least one of the following: the relative distance of the target object to the terminal; the queue status of the area in which the target object is located.

FIG. 9 is a flowchart of a process for displaying application information according to various embodiments of the present application.

Referring to FIG. 9, process 900 for displaying application information is provided. Process 900 can be implemented by terminal 100 of FIG. 1, terminal 600 of FIG. 6, and/or terminal 1000 of FIG. 10. Process 900 can implement notification 201 of FIG. 2, notification 310 and/or notification 320 of FIG. 3, and/or notification 410 of FIG. 4.

At 910, a notification box is displayed. In some embodiments, a notification box of a designated application is displayed in the current display interface of a terminal.

At 920, dynamic information is displayed. In some embodiments, dynamic information associated with the designated application is displayed. The dynamic information can be displayed in an expanded area of the notification box. In some embodiments, the dynamic information is displayed when the notification box is displayed. In some embodiments, the dynamic information is displayed in the expanded area of the notification box in response to receiving a trigger instruction (e.g., a user's trigger instruction generated in response to a user input being received).

In some embodiments, a computer terminal is provided. The computer terminal may be any computer terminal device within a cluster of computer terminals. In some embodiments, the aforesaid computer terminal may also be replaced with a terminal device such as a mobile terminal.

In some embodiments, the computer terminal may be located on any one network device among multiple network devices of a computer network.

In some embodiments, the computer terminal can execute the program code for the application information display process. For example, the computer terminal can execute the program code for the application information display process including displaying the notification box of a designated application in the current display interface of the terminal; receiving a trigger instruction directed at the notification box; and displaying dynamic information of the designated application in an expanded area of the notification box upon being triggered by the trigger instruction.

FIG. 10 is a structural block diagram of a computer terminal according to various embodiments of the present application.

Referring to FIG. 10, terminal 1000 for displaying application information is provided. Terminal 1000 can implement process 500 of FIG. 5, process 700 of FIG. 7, process 800 of FIG. 8, process 900 of FIG. 9, and/or process 1100 of FIG. 11. Terminal 1000 can implement notification 201 of FIG. 2 (e.g., which can be shown during screen-lock), notification 310 and/or notification 320 of FIG. 3 (e.g., which can be shown during screen-lock), and/or notification 410 of FIG. 4 (e.g., which can be shown during screen-lock). Terminal 1000 can be implemented in connection with terminal 100 of FIG. 1, and/or terminal 600 of FIG. 6.

Computer terminal 1000 comprises: one or more (only one shown in the figure) processors 1010, memory 1020, and display 1030.

Memory 1020 may be used to store software programs and modules, (e.g., program instructions/modules corresponding to an application information display process). By running software programs and modules stored in memory 1020, processor 1010 executes various function applications and data processing (i.e., processor 10100 implements the process for displaying application information). Memory 1020 may comprise high-speed random access memory. Memory 1020 may further comprise non-volatile memory, such as one or more magnetic storage devices, flash memory, or other non-volatile solid-state memory. In some embodiments, memory 1020 may further comprise memory that is remotely disposed relative to processor 1010. Such remote memory may be connected to the computer terminal 1000 via a network. Examples of the aforesaid network comprise but are not limited to the Internet, corporate intranets, local area networks, mobile communication networks, and combinations thereof.

Through a transmitting means, processor 1010 can invoke information and applications stored in memory to execute displaying the notification box of a designated application in the current display interface of the terminal; receiving a trigger instruction directed at the notification box; and displaying dynamic information of the designated application in an expanded area of the notification box upon being triggered by the trigger instruction.

Processor 1010 can further execute displaying the notification box of a designated application in the current display interface of the terminal, and displaying dynamic information of the designated application in an expanded area of the notification box.

Processor 1010 can further execute activating the designated application, obtaining dynamic information on a target object monitored by the designated application, and displaying the dynamic information in a notification box of the terminal.

Processor 1010 can further execute program code for obtaining from the designated application the dynamic information pre-stored by the designated application; sending a request message to the designated application, the request message corresponding to a triggering of the designated application to request the dynamic information from a network-side server; and receiving the dynamic information received by the designated application from the network-side server.

A person with ordinary skill in the art can understand that the structure shown in FIG. 10 is merely illustrative. Computer terminal 1000 may be a smartphone (such as an Android phone or an iOS phone), a tablet computer, a palmtop computer, a mobile Internet device (MID), a PAD, or other such device. FIG. 10 does not limit the structures of the aforesaid electronic devices. For example, computer terminal 1000 may further comprise more or fewer components (such as network interfaces, display devices, etc.) than shown in FIG. 10 or may have a configuration that differs from the one shown in FIG. 10.

A person with ordinary skill in the art may understand that all or some of the steps in the various methods of the embodiments described above can be carried out by instructing terminal device-related hardware via programs. These programs may be stored in computer-readable storage media. The storage media may include: Flash disks, read-only memory (ROM), random access memory (RAM), magnetic disks, optical disks, etc.

FIG. 11 is a flowchart of a process for displaying application information according to various embodiments of the present application.

Referring to FIG. 11, process 1100 for displaying application information is provided. Process 1100 can be implemented by terminal 100 of FIG. 1, terminal 600 of FIG. 6, and/or terminal 1000 of FIG. 10. Process 1100 can implement notification 201 of FIG. 2 (e.g., which can be shown during screen-lock), notification 310 and/or notification 320 of FIG. 3 (e.g., which can be shown during screen-lock), and/or notification 410 of FIG. 4 (e.g., which can be shown during screen-lock).

At 1110, an instruction associated with a notification box is obtained. In some embodiments, the terminal receives an input directed to the notification box from the user. The input can correspond to a selection of the notification box or an element displayed therein. In some embodiments, a first instruction directed at a notification box in the current display interface of a terminal is received. The first instruction can correspond to a request or instruction for expanding the notification box. The notification box is configured to display notification information associated with the designated application. In some embodiments, the designated application could comprise one or more applications, or the notification box displays notification information for one or more applications.

At 1120, information is displayed in the expanded rea. For example, the interface information of the designated application is displayed in the expanded area of the notification box. The interface information can correspond to information that exhibits dynamic data of the designated application. For example, the interface information can comprise the dynamic information.

The modules described as separate components may or may not be physically separate, and components displayed as modules may or may not be physical modules. They can be located in one place, or they can be distributed across multiple network modules. The embodiment schemes of the present embodiments can be realized by selecting part or all of the modules in accordance with actual need.

Furthermore, the functional modules in the various embodiments of the present invention can be integrated into one processor, or each module can have an independent physical existence, or two or more modules can be integrated into a single module. The aforesaid integrated modules can take the form of hardware, or they can take the form of hardware combined with software function modules.

Each of the embodiments contained in this description is described in a progressive manner, the explanation of each embodiment focuses on areas of difference from the other embodiments, and the descriptions thereof may be mutually referenced for portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, embodiments of the present application may employ one or more forms of computer products that implement computer-operable storage media (including but not limited to magnetic disk storage devices, CD-ROMs, and optical storage devices) containing computer-operable computer code.

In one typical configuration, the computer equipment comprises one or more processors (CPUs), input/output interfaces, network interfaces, and memory. Memory may include such forms as volatile storage devices in computer-readable media, random access memory (RAM), and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include transitory computer-readable media, (transitory media), such as modulated data signals and carrier waves.

The embodiments of the present application are described with reference to flowcharts and/or block diagrams based on methods, terminal equipment (systems), and computer program products of the embodiments of the present application. Please note that each flowchart and/or block diagram within the flowcharts and/or block diagrams and combinations of flowcharts and/or block diagrams within the flowcharts and/or block diagrams can be realized by computer commands. These computer program commands can be provided to the processors of general-purpose computers, specialized computers, embedded processor devices, or other programmable data processing terminals to produce a machine. The commands executed by the processors of the computers or other programmable data processing terminal equipment consequently give rise to devices for implementing the functions specified in one or more processes in the flowcharts and/or one or more blocks in the block diagrams.

These computer program commands can also be stored in computer-readable memory that can guide the computers or other programmable data processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data processing terminal equipment and made to execute a series of steps on the computers or other programmable data processing terminal equipment so as to give rise to computer-implemented processing. The commands executed on the computers or other programmable data processing terminal equipment thereby provide the steps of the functions specified in one or more processes in the flowcharts and/or one or more blocks in the block diagrams.

The numbering of the embodiments of the present application is merely descriptive and does not indicate the relative strengths or weaknesses of the embodiments.

In the aforesaid embodiments of the present application, the description of each embodiment has its respective emphasis, and parts of an embodiment are not described in detail. One may refer to other embodiments for the relevant descriptions.

Please understand that, in several embodiments provided by the present application, the disclosed technical content may be realized in other ways. The device embodiments described above are merely illustrative. For example, the division into said units is merely a division by logical function. When actually implemented, there may be other forms of division. For example, multiple units or components may be combined or integrated into another system, or some features might be omitted or not executed. In addition, the interposed couplings or direct couplings or communication connections that are displayed or discussed may be indirect couplings or communication links that pass through some interfaces, units, or modules. They may be electrical or may take another form.

The units described as separate components may or may not be physically separate, and components displayed as units may or may not be physical units. They can be located in one place, or they can be distributed across multiple network units. The embodiment schemes of the present embodiments can be realized by selecting part or all of the units in accordance with actual need.

In addition, each functional unit in each of the embodiments of the present application may be integrated into a processing unit, or each unit may have an independent physical existence. Or two or more units may be integrated into one unit. The aforesaid integrated units may take the form of hardware, and they may also take the form of software function units.

If the integrated units are realized in the form of software functional units and are sold or used as separate products, they may be stored on computer-readable storage media. Based on such an understanding, the technical scheme of the present application, whether intrinsically or with respect to portions that contribute to the prior art, or with respect to all or part of the technical scheme, is realizable in the form of software products. These computer software products can be stored on storage media (such as ROM/RAM, magnetic disks, and optical disks) and include a certain number of instructions used to cause a piece of terminal equipment (which could be a mobile telephone, a computer, a server, or network equipment) to execute the methods described in the embodiments of the present application. The storage medium described above encompasses: USB flash drive, mobile hard drive, read-only memory (ROM), random access memory (RAM), portable hard drives, magnetic disks, or optical disks, or various other media that can store program code.

The description above is only of preferred implementations of the present application. It should be pointed out that persons with ordinary skill in the art can, without departing from the principles of the present application, also produce a number of improvements and embellishments, and that such improvements and embellishments should also be regarded as falling within the scope of protection of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an instruction associated with triggering a displaying object;
accessing dynamic information pertaining to a designated application executing on a terminal; and
displaying the dynamic information associated with the designated application in the displaying object.

2. The method of claim 1, wherein the displaying object is a notification box, a floating window, or a locked screen.

3. The method of claim 1, wherein the dynamic information associated with the designated application is displayed in an expanded area of the displaying object.

4. The method of claim 3, wherein the expanded area of the displaying object is displayed on a current display interface of the terminal.

5. The method of claim 1, wherein the dynamic information is associated with a relationship between a target object associated with the designated application and the terminal.

6. The method of claim 1, wherein the dynamic information comprises at least one of the following:
a relative distance of a target object associated with the designated application to the terminal; and
queue information associated with an area at which the target object is located.

7. The method of claim 1, wherein before the displaying of the dynamic information, the method further comprises:
obtaining from a storage the dynamic information, wherein the dynamic information is pre-stored by the designated application.

8. The method of claim 1, wherein before the displaying of the dynamic information, the method further comprises:
communicating a request message to the designated application, the request message causing the designated application to request the dynamic information from a server; and
receiving the dynamic information from the server.

9. The method of claim 1, further comprising:
activating the designated application; and
obtaining the dynamic information, wherein the dynamic information comprises information associated with a target object monitored by the designated application.

10. The method of claim 1, further comprising:
displaying an icon of the designated application, an identifier associated with a target object monitored by the designated application, or both, while displaying the dynamic information in the displaying object of the terminal.

11. The method of claim 1, wherein the dynamic information comprises contextual information associated with the terminal or a user of the terminal.

12. The method of claim 1, wherein the dynamic information comprises contextual information associated with a relationship between a target object monitored by the designated application and the terminal or a user of the terminal.

13. The method of claim 1, wherein the dynamic information comprises one or more of a relative location information and a relative distance, wherein at least one of the one or more of the relative location information and the relative distance is displayed in the displaying object.

14. The method of claim 13, wherein the one or more of the relative location information and the relative distance is used to display dynamic information on an electronic map in the displaying object.

15. The method of claim 1, wherein the dynamic information comprises queue information associated with a target object monitored by the designated application and the terminal or a user of the terminal.

16. The method of claim 15, wherein the queue information is displayed in the displaying object, and comprises one or more of: an indication of a size of the queue associated with the target object in the queue, an indication of a position of the terminal in the queue, an indication of a position of the user of the terminal in the queue, and an estimated wait time.

17. The method of claim 1, further comprising:
in the event that the dynamic information comprises multiple pieces of information, determining a number of pieces of information comprised in the dynamic information;
determining whether the number of pieces of information comprised in the dynamic information is greater than a preset threshold value; and
in the event that the number of pieces of information comprised in the dynamic information is greater than the preset threshold value, displaying the multiple pieces of information based at least in part on priority levels respectively associated with the multiple pieces of information.

18. The method of claim 17, wherein the multiple pieces of information are displayed in a loop display based at least in part on the priority levels.

19. A method, comprising:
receiving an input directed at a notification box in a current display interface of a terminal, wherein the input corresponds to a request to expand the notification box, the notification box being configured to display notification information of a designated application; and
displaying interface information of the designated application in the expanded area of the notification box, wherein the interface information indicates dynamic data of the designated application.

20. A terminal, comprising:
one or more processors configured to:
receive an instruction associated with triggering a displaying object;
access dynamic information pertaining to a designated application executing on the terminal; and
output the dynamic information associated with the designated application in the displaying object to be displayed; and
one or more memories coupled to the one or more processors, configured to provide the one or more processors with instructions.

21. A terminal, comprising:
one or more processors configured to:
receive an input directed at a displaying object in a current display interface, wherein the input corresponds to a request to expand the displaying object, the displaying object being configured to display notification information of a designated application; and
output, for display, interface information of the designated application in expanded area of the displaying object, wherein the interface information indicates dynamic data of the designated application; and
one or more memories coupled to the one or more processors, configured to provide the one or more processors with instructions.

22. A computer program product, the computer program product being embodied in a non-transitory computer readable storage medium and comprising computer instructions for:
receiving an instruction associated with triggering a displaying object;
accessing dynamic information pertaining to a designated application executing on a terminal; and
displaying the dynamic information associated with the designated application in the displaying object.

23. A method, comprising:
obtaining dynamic information of an application, the dynamic information comprising information collected in real time from the application; and
displaying the dynamic information in a displaying object.

24. The method of claim 23, wherein the displaying object comprises a notification box, a floating window, or a locked screen.

25. The method of claim 23, wherein information collected in real time comprises information collected periodically.

26. A terminal, comprising:
one or more processors configured to:
obtain dynamic information of an application, the dynamic information comprising information collected in real time from the application; and
output the dynamic information to be displayed in a displaying object; and
one or more memories coupled to the one or more processors, configured to provide the one or more processors with instructions.

27. A computer program product, the computer program product being embodied in a non-transitory computer readable storage medium and comprising computer instructions for:
obtaining dynamic information of an application, the dynamic information comprising information collected in real time from the application; and
displaying the dynamic information in a displaying object.
